(19) United States
(12) Patent Application Publication
(10) Pub. No.: US 2010/0317813 A1
(43) Pub. Date: Dec. 16, 2010

(54) SUPPORTED CATALYST FOR THE PREPARATION OF (CO)MONOMERS OF ETHYLENICALLY UNSATURATED MONOMERS

(76) Inventors: Peter Tait, Riyadh (SA); Atieh Abu-Raqabah, Riyadh (SA); Rami Bakleh, Riyadh (SA); Eyad Abdulrazk, Riyadh (SA)

Correspondence Address: SABIC AMERICAS, INC., 1600 INDUSTRIAL BLVD., SUGAR LAND, TX, 77478, US

(21) Appl. No.: 12/449,506

(22) PCT Filed: Feb. 20, 2008
(86) PCT No.: PCT/EP2008/001336

§ 371 Date: Mar. 22, 2010

(30) Foreign Application Priority Data
Feb. 22, 2007 (EP) 07003639.7

(51) Int. Cl. C08F 4/76; B01J 29/06; B01J 31/14

(52) U.S. Cl. 526/129; 502/62; 526/130

(57) ABSTRACT

The present invention is directed to a supported catalyst comprising
1. a precursor comprising a solid particulate support material in the form of mesoporous silicate structure MCM-48 wherein the silicate structure is treated with an aluminoxane compound and/or an organoaluminum compound and
2. a transition metal complex of a Group 4 transition metal of the periodic system being coordinative connected to two phenoxy-imine ligands.

The catalyst is applied in the (co)polymerization of olefins.

The present invention relates to a supported catalyst.

The invention also relates to a process for the preparation of (co)polymers of ethylenically unsaturated monomers with use of this catalyst.

Homogeneous and heterogeneous catalyst systems and processes for the production of polyolefins are known. The use of homogeneous catalysts usually results in relatively high overall polymerization rates whereas the polymer is rather difficult to isolate and the polymers have a relatively poor morphology and a low bulk density. Another significant problem of existing olefin (co)polymerization processes being based on homogeneous or heterogeneous catalysts is reactor fouling.

In order to overcome these drawbacks supported polymerization catalysts for example supported Ziegler-Natta catalysts and to metallocene catalysts have been developed.

U.S. Pat. No. 2,825,721 discloses silica supported chromium catalysts for the production of high density polyethylene.

U.S. Pat. No. 4,701,421 discloses the preparation of a supported metallocene catalyst which requires the treatment of a calcinated silica with a solution containing a metallocene and a titanium tetra-halide. This supported catalyst is used together with methylaluminoxane and trimethylaluminum as co-catalysts to polymerize ethylene and to copolymerize ethylene and but-1-ene.

U.S. Pat. No. 4,808,561 teaches that higher polymerization activities may be obtained when calcinated silica is first treated with an aluminoxane prior to the treatment with a metallocene.

U.S. Pat. No. 4,554,704 discloses the preparation of a catalyst precursor by reacting first methylaluminoxane with a metallocene and by subsequently adding dehydrated silica.

Also the so-called post-metallocene type catalysts are known.

Brookhart et al. (J. Am. Chem. Soc. 117, 6414, 1995) disclose the use of a nickel complex, possessing a di-imine ligand, and activated by either methylaluminoxane or a borate cocatalyst system, for the production of branched polyethylene.

Gibson et al (Chem. Commun., 849, 1998) and Brookhart et al (J. Am. Chem. Soc. 120, 4049, 1998) describe the use of iron and cobalt complexes resulting in a very high ethylene polymerization activity.

Grubbs et al (Organometallics, 17, 3149, 1998) disclose the use of a nickel complex with a phenoxy-imine ligand which when activated showed a high ethylene polymerization activity and a high functional group tolerance.

EP 0 874 005 A1 discloses a transition metal complex for the polymerization of α-olefins wherein the complex has one or more phenoxy-imine ligands which can be used on inorganic or organic support materials in the form of a granular or a particulate solid. Methyl-aluminoxane may be applied as a cocatalyst.

The global demand of polyolefins is still increasing and consequently further improvement in the processes for the production of olefin (co)polymers is desired.

It is the object of the present invention to provide a catalyst system and a process for the production of polyolefins, especially polyethylene, exhibiting substantially no reactor fouling and providing free-flowing (co)polymers having a high bulk density.

The supported catalyst for olefin (co)polymerization according to the invention comprises at least one supported catalyst precursor and at least one transition metal complex wherein
1. the precursor comprises a solid particulate support material in the form of mesoporous silicate structure MCM-48 which has been treated with an aluminoxane compound and/or an organoaluminum compound and
2. the metal complex is a transition metal complex of a Group 4 transition metal of the periodic system being coordinative connected to at least two phenoxy-imine ligands.

The mesoporous silicate structure MCM-48 is described in “A simplified description of MCM-48” (Anderson, Zeolites, 1997, vol. 19, pages 220 to 227). Mesoporous silicate structure MCM-48 at a short-range scale from 1 to 10 Å is an amorphous hydroxylated silicate. The predominant species from which MCM-48 is constructed usually are Si[OSi]₄ and Si[OSi]₃OH units which generally occur in a ratio of about 2:1. In one embodiment the wall thickness in MCM-48 may range between 3 Å and 15 Å. In one embodiment MCM-48 forms highly regular particulates of micron size. In another embodiment the particulate support material has an average size in the range between 0.05 and 10 μm, more preferably between 0.1 and 1 μm.

In spite of essential differences between MCM 48 and MCM 41 the preparation of MCM-48 may take place according to processes as known for MCM 41 as described for example in Beck et al., J. Am. Chem. Soc. 1992, 114, 10834, and Kregse et al., Nature 1992, 359, 710. There exist several important differences between the hexagonal MCM 41 and the cubic MCM 48 regarding for example the organization of the particles. Furthermore MCM 48 has a three dimensional channel whereas MCM 41 has a one dimensional channel system.

The precursor may comprise additionally other solid particulate supports and MCM-48 may be treated more than once with said compounds whereas there may additionally be present other compounds than the aluminoxane compound and/or organoaluminum compound. Furthermore the transition metal complex may additionally comprise another Group 4 transition metal of the periodic system.

According to a preferred embodiment of the invention the supported catalyst precursor further comprises in addition to MCM 48 another support material. This support material may be selected for example from the group consisting of silicium-, aluminum-, magnesium-, titanium-, zirconium-, borium-, calcium- and/or zinc-oxide, aluminum silicate, polysiloxane, sheet silicate, zeolite different from MCM-48, clay, clay mineral, metal halide, a polymer and/or a mixed oxide such as for example SiO₂—MgO or SiO₂—TiO₂.

Examples of suitable clays and clay minerals include kaolin, bentonite, kibushi clay, the gairome clay, allophone, hisingerite, pyrophyllite, mica, montmorillonite, vermiculite, chlorite, palygorskite, kaolinite, nacrite, dickite and halloysite. Preferable these minerals are subjected to a chemical treatment.

In a preferred embodiment the support material has been pre-treated prior to being treated with an aluminoxane compound and/or an organoaluminum compound. The pre-treatment may take place by thermal and/or chemical pre-treatment processes for example heating, i.e. calcination, and/or sulfonylation or silanation. The heating may take place at a temperature in the range between 100° and 900° C.

Thermal and/or chemical pre-treatment processes result in the modification of acidic hydroxyl groups being present on the support material. The thermal pre-treatment may take place by heating the support material in vacuum or while purging with an inert gas such as nitrogen, for example at a temperature in the range between 120° C. and 850° C. during 1 and 24 hours.

A suitable chemical pre-treatment process uses a chemical agent for example thionyl chloride, silicon tetrachloride, chlorosilanes for example dichlorodimethyl silane or hexamethyldisiliazane. In a preferred embodiment the support material is slurried in particulate form in a low boiling inert hydrocarbon diluent for example hexane under a dry nitrogen atmosphere. Next the solution of the chemical agent, preferably in the same diluent, can then be added during a period between for example 1 and 4 hours, while maintaining a temperature in the range between 25° C. and 125° C., preferably in the range between 50° C. and 70° C. Next the resultant solid particulate material is isolated, washed with a dry inert diluent and dried under vacuum. Suitable diluents include for example a hydrocarbon diluent for example hexane or heptane and an aromatic diluent for example toluene. The chemically pre-treated support material may be subjected subsequently to a heat treatment.

According to a preferred embodiment of the invention the support comprises a composite being formed from MCM-48 and silicium oxide (silica) and/or aluminum oxide (alumina).

The MCM-48 support material or the support material comprising MCM-48 and another support material may be treated with for example an aluminoxane compound and/or an organoaluminum compound. The compound may be diluted with a hydrocarbon for example pentane, hexane, heptane or octane and/or an aromatic diluent such as benzene or toluene. The resulting solid is isolated, washed with a hydrocarbon or an aromatic diluent and dried. Preferably a thermally and/or chemically pre-treatment takes place before the treatment with the aluminoxane compound and/or the an organoaluminum compound,

Suitable aluminoxane compounds may be obtained for example by reaction of a trialkylaluminum, for example trimethylaluminum, and water. Generally the aluminoxane compound has an oligomeric structure according to

(R—AL—O)ₖ and (R—AL—O)ₖAlR₂.

In these formulae R may represent a C₁₋₁₀ alkyl group and k may be an integer from 2 to 30. Suitable alkyl groups include for example, methyl, ethyl, propyl, butyl and pentyl.

Preferably R is methyl and k is 4 to 25.

Generally the support material is reacted with the aluminoxane compound under inert conditions. The support material may be treated with a solution or a mixture containing said aluminoxane in a hydrocarbon and/or an aromatic diluent. Typically such a mixture is stored for a period between 1 and 5 hours at 30 to 60° C. before the solid support/aluminoxane material is isolated, thoroughly washed and dried. This process results in the alkylation and in the moderation of the reductive properties of the aluminoxane compound.

Suitable aluminoxane compounds include for example MAO (methylaluminoxane) and MMAO (modified methylaluminoxane, wherein the modification takes place lfor example by addition of Al(i-Bu)₃).

Suitable organoaluminum compounds include for example compounds of the formula

R₃₋ₘXₘAl

wherein m is 0, 1, or 2,

wherein X is a halide

wherein R is a hydrocarbon group or an aryl group for example methyl, ethyl, i-propyl, n-propyl, i-butyl, n-butyl, t-butyl or phenyl or substituted phenyl.

The halide may be chloride, bromide or fluoride

Suitable group 4 transition metals include Ti, Zr and Hf. These metals may be coordinative connected to at least two phenoxy-imine ligands as described for example in EP 874 005.

According to a preferred embodiment of the invention the aluminoxane compound and/or an organoaluminum compound is solved in an inert diluent. The diluent may be a hydrocarbon for example pentane, hexane, heptane or octane and/or an aromatic diluent for example benzene or toluene.

In a preferred embodiment the transition metal complex of at least one Group 4 transition metal is represented by the following formula (I):

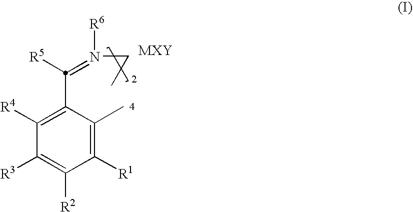

wherein
M=a Group 4 transition metal,
A=selected from the group consisting of O, S or N—R⁷,
R¹ to R⁷=the same or different and is hydrogen or a hydrocarbon radical containing from 1 to 21 carbon atoms, a silicon-containing hydrocarbon radical, or a hydrocarbon radical wherein two carbon atoms are joined together to form a C₄- to C₆-ring, or halogen or an alkoxy radical,
X=halide and
Y=halide

Preferably the variables in Formula (I) have the following meaning:
M=Zr,
A=O,
R¹=t-butyl,
R² to R⁶=H,
R⁶=phenyl, and
X, Y=chloride.

According to a further preferred embodiment the transition metal complex is bis-(N-[(3-t-butylsalicylidene)anilinato]zirconium (IV)-dichloride).

The residues R² to R⁵ may be the same or different, and can be each a hydrogen atom, a halogen atom, a hydrocarbon group, a heterocyclic compound residue, a hydrocarbon-substituted silyl group, a hydrocarbon-substituted siloxy group, an alkoxy group, an alkylthio group, and aryloxy group, an arylthio group, an ester group, a thioester group, a cyano group, a nitro group, a carboxyl group, a sulfo group, a mercapto group or a hydroxyl group.

The residue R¹ may be a halogen atom, a hydrocarbon group, a hydrocarbon-substituted silyl group, a hydrocarbon-substituted siloxy group, an alkoxy group, an alkylthio group, an aryloxy group, an arylthio group, an ester group, a thioester group, an amido group, an imido group, imino group, a sulfonester group, a sulfonamide group or a cyano group. Preferably, R¹ is methyl, ethyl, n- or i-propyl, n-, i- or t-butyl or trimethylsilyl.

The residue R⁶ may be a hydrocarbon group, a hydrocarbon-substituted silyl group, a hydrocarbon-substituted siloxy group, an alkoxy group, an alkylthio group, an aryloxy group, an arylthio group, an ester group, a thioester group, a sulfonester group or a hydroxyl group. R⁶ preferably is phenyl or substituted phenyl.

Two or more of R¹ to R⁶ may also be bonded to each other to form a ring.

Examples of suitable hydrocarbon groups include straight-chain or branched alkyl groups of 1 to 30, preferably 1 to 20 carbon atoms, for example methyl, ethyl, n-propyl, isopropyl, n-butyl, isobutyl, sec-butyl, tert-butyl, neopentyl and n-hexyl; straight-chain or branched alkenyl groups of 2 to 30, preferably 2 to 20 carbon atoms, such as vinyl, allyl and isopropenyl; straight-chain or branched alkynyl groups of 2 to 30, preferably 2 to 20 carbon atoms, such as ethynyl and propargyl; cyclic saturated hydrocarbon groups of 3 to 30, preferably 3 to 20 carbon atoms, such as cyclopropyl, cyclobutyl, cyclopentyl, cyclohexyl and adamantyl; cyclic unsaturated hydrocarbon groups of 5 to 30, preferably 5 to 20 carbon atoms, such as cyclopentadienyl, indenyl and fluorenyl; and aryl groups of 6 to 30, preferably 6 to 20 carbon atoms, such as phenyl, benzyl, naphthyl, biphenyl and terphenyl.

The hydrocarbon groups can also be substituted with halogen atoms, and may comprise for example halogenated hydrocarbon groups of 1 to 30, preferably 1 to 20 carbon atoms, such as trifluoromethyl, pentafluorophenyl and cholophenyl. The hydrocarbon groups can also be substituted with other hydrocarbon groups and may comprise for example aryl-substituted alkyl groups such as benzyl and cumyl. Further, the hydrocarbon groups can have heterocyclic compound residues; oxygen-containing groups such as alkoxy, aryl, ester, ether, acyl, carboxyl, carbonato, hydroxy, peroxy and carboxylic acid anhydride groups; nitrogen-containing groups such as ammonium salts of amino, imino, amide, imide, hydrazino, hydrazono, nitro, nitroso, cyano, isocyano, cyanic acid ester, amidino and diazo groups; boron-containing groups such as borandiyl, borantriyl and diboranyl groups; sulfur-containing groups such as mercapto, thioester, dithioester, alkylthio, arylthio, thioacyl, thioether, thiocyanic acid ester, isothiocyanic acid ester, sulfon ester, sulfon amide, thiocarboxyl, dithiocarboxyl, sulfo, sulfonyl, sulfinyl and sulfenyl groups; phosphorus-containing groups such as phosphido, phosphoryl, thiophosphoryl and phosphato groups; silicon-containing groups; germanium-containing groups; and tin-containing groups.

Particularly preferable are straight-chain or branched alkyl groups of 1 to 30, preferably 1 to 20 carbon atoms, such as methyl, ethyl, n-propyl, isopropyl, n-butyl, isobutyl, sec-butyl, tert-butyl, neopentyl and n-hexyl; aryl groups of 6 to 30, preferably 6 to 20 carbon atoms, such as phenyl, naphthyl, biphenyl, terphenyl, phenanthryl and antracenyl; and these aryl groups which are substituted with 1 to 5 substituents such as alkyl or alkoxy groups of 1 to 30, preferably 1 to 20 carbon atoms, aryl or aryloxy groups of 6 to 30, preferably 6 to 20 carbon atoms.

Examples of suitable heterocyclic residues include nitrogen-containing compounds (for example, pyrrole, pyridine, pyrimidine, quincline and triazine), oxygen-containing compounds (for example, furan and pyran) and sulfur-containing compounds (for example, thiophene), and these heterocyclic residues, which are substituted with substituents such as alkyl or alkoxy groups of 1 to 20 carbon atoms. Examples of the silicon-containing groups include silyl, siloxy, hydrocarbon-substituted silyl groups such as methylsilyl, dimethylsilyl, trimethylsilyl, ethylsilyl, diethylsilyl, triethylsilyl, diphenylmethylsilyl, triphenylsilyl, dimethylphenylsilyl, dimethyl-t-butylsilyl and dimethyl(pentafluorophenyl)silyl, preferably methylsilyl, dimethylsilyl, trimethylsilyl, ethylsilyl, diethylsilyl, triethylsilyl and triphenylsilyl, particularly preferably trimethylsilyl, triethylsilyl, triphenylsilyl and dimethylphenylsilyl, and hydrocarbon-substituted siloxy groups such as trimethylsiloxy. Examples of the alkoxy groups include methoxy, ethoxy, n-propoxy, isopropoxy, n-butoxy, isobutoxy and tert-butoxy. Examples of the alkylthio groups include methylthio and ethylthio. Examples of the aryloxy groups include phenoxy, 2,6-dimethylphenoxy and 2,4,6-trimethylphenoxy. Examples of the arylthio groups include phenylthio, methylphenylthio and naphthylthio. Examples of the acyl groups include formyl, acyl, benzoyl, p-chlorobenzoyl and p-methoxybenzoyl. Examples of the ester groups include acetyloxy, benzoyloxy, methoxycarbonyl, phenoxycarbonyl and p-chlorophenoxycarbonyl. Examples of the thioester groups include acetylthio, benzoylthio, methylthiocarbonyl and phenylthiocarbonyl. Examples of the amido groups include acetamido, N-methylacetamido and N-methylbenzamido. Examples of the imido groups include acetimido and benzimido. Examples of the amino groups include dimethylamino, ethylmethylamino and diphenylamino. Examples of the imino groups include methylimino, ethylimino, propylimino, butylimino and phenylimino. Examples of the sulfonester groups include methylsulfonato, ethylsulfonato and phenylsulfonato. Examples of the sulfonamido groups include phenylsulfonamido, N-methylsulfonamido and N-methyl-p-toluenesulfonamido.

According to a preferred embodiment of the invention the process for the preparation of the supported catalyst comprises the following steps:
a) providing at least one solid particulate support material in the form of mesoporous silicate structure MCM-48,
b) forming a slurry of said particulate support material in an inert diluent and mixing said slurry with at least one aluminoxane compound and/or at least one organoaluminum compound, preferably in an inert diluent, or mixing said support material as such to an aluminoxane compound and/or at least one organoaluminum compound in an inert diluent,
c) isolating the solid material obtained in step b),
d) preparing a slurry from the solid material obtained in step c) in an inert diluent,
e) mixing the slurry obtained in step d) and the Group 4 transition metal complex being coordinative connected to at least two phenoxy-imine ligands in an inert diluent.

Furthermore after step d) and step e) the solid supported catalyst obtained may be isolated (step f). Isolation and the mixing can be performed for example via spray drying and/or precipitation.

According to a further preferred embodiment of the invention the process the preparation of a (co)polymer from ethylenically unsaturated compounds comprises the following steps:
a) adding of at least one ethylenically unsaturated monomer to a reaction vessel,
b) mixing the precursor comprising a solid particulate support material in the form of mesoporous silicate structure MCM-48 and the at least one transition metal complex of at least one Group 4 transition metal being coordinative connected to at least two phenoxy-imine ligands in an inert diluent,
c) adding the mixture obtained according to step b) to the at least one ethylenically unsaturated monomer as obtained in step a),
d) adding at least one aluminoxane compound and/or an organoaluminum compound in an inert diluent,
e) (co)polymerizing the ethylenically unsaturated compound(s), and
f) isolating the prepared (co)polymer.

Preferably the adding of the at least one ethylenically unsaturated monomer to a reaction vessel takes place in an inert diluent.

Preferably at least one organometal alkyl compound, for example. a trialkylaluminum compound such as triethylaluminum or triisobutylaluminum, is added to the reaction vessel prior to step c).

According to a preferred embodiment of the invention at least one ethylenically unsaturated comonomer is added to the reaction vessel, in order to prepare copolymers. Preferably this addition takes place prior to step c)

Improved results related to morphology, lack of reactor fouling and polymerization activity are obtained when the aluminoxane treated MCM-48 solid supported catalyst precursor is mixed during a relative short time with the transition metal phenoxy imine catalyst (step b) prior to the addition to the ethylenically unsaturated monomer(s) to be (co)polymerized, i.e. prior to step c). This pre-mixing step may take place between 30 seconds and 10 minutes, preferably between 1 and 4 minutes and more preferably about 2 minutes.

According to a further preferred embodiment of the invention the process the preparation of a (co)polymer from ethylenically unsaturated monomers comprises the following steps:
a) adding at least one ethylenically unsaturated monomer to a reaction vessel to an inert diluent in said reaction vessel,
b) adding the supported catalyst according to the invention or the catalyst system according to the invention to the reaction vessel,
c) (co)polymerizing the ethylenically unsaturated monomer(s), and
d) isolating the prepared (co)polymer.

Preferably at least one organometal alkyl compound, for example. a trialkylaluminum compound such as triethylaluminum or triisobutylaluminum, is added to the reaction vessel prior to step b).

According to a further preferred embodiment after b) at least one aluminoxane compound and/or an organoaluminum compound in an inert diluent is added to the reaction vessel.

In a preferred embodiment of the invention at least one ethylenically unsaturated comonomer is added, in particular prior to step b) to the reaction vessel, in order to prepare copolymers.

According to another preferred embodiment of the invention the process the preparation of a (co)polymer from ethylenically unsaturated monomers comprises the following steps:
a) adding of at least one ethylenically unsaturated monomer to an inert diluent in a reaction vessel,
b) adding a solid particulate support material in the form of mesoporous silicate structure MCM-48
c) adding at least one transition metal complex of at least one Group 4 transition metal being coordinative connected to at least two phenoxy-imine ligands in an inert diluent,
d) (co)polymerizing the ethylenically unsaturated monomer(s) and
e) isolating the prepared (co)polymer.

Preferably after step c) at least one aluminoxane compound and/or an organoaluminum compound in an inert diluent is added to the reaction vessel.

Preferably at least one organometal alkyl compound, for example. a trialkylaluminum compound such as triethylaluminum or triisobutylaluminum, is added to the reaction vessel prior to step b).

In a preferred embodiment of the invention at least one ethylenically unsaturated comonomer is added, in particular prior to step b) to the reaction vessel, in order to prepare copolymers.

Suitable ethylenically unsaturated monomers and comonomers include for example alpha-olefins, vinylaromatic compounds or (meth)acrylic derivatives.

Suitable alpha-olefins include for example ethylene, propylene, but-1-en or pent-1en.

Suitable vinylaromatic compounds include for example styrene.

Suitable (meth) acrylic derivatives include for example (meth)acrylic acid and (meth)acrylic esters for example methyl(meth)acrylate.

According to a preferred embodiment of the invention the polymer obtained with the process according to the invention is an ethylene polymer.

Suitable diluents to be applied in the polymerization reaction include for example inert hydrocarbon solvents such as pentane, hexane, heptane, octane, benzene and/or toluene.

Preferably the same diluent is applied in the several steps of the process.

According to a preferred embodiment of the invention in all processes for the preparation of the (co)polymers the supported catalyst precursor further comprises in addition to MCM 48 another support material as described in the foregoing.

Exemplary, in one embodiment a polymerization reactor is prepared by heating and evacuation and filled with dried nitrogen. The required volume of dried hydrocarbon or aromatic diluent can then be added and the reactor and the diluent are heated to the required temperature. The diluent can then be purged or saturated with an ethylenically unsaturated monomer. It is preferred to subsequently add a volume of an aluminum alkyl solution, for example triisobutylaluminum (TIBAL), in particular in the same diluent.

In case of a copolymerization the comonomer can preferably be added at this stage. In the following, a volume of a mixture of the aluminoxane treated MCM-48 support which has been slurried, preferably in the same diluent, together with the required amount of the aforementioned phenoxy-imine catalyst, preferably pre-contacted for a short time as described above, can be added. Then, the reactor temperature can be adjusted to the final polymerization temperature and the pressure of the ethylenically unsaturated compound can be adjusted to the required pressure.

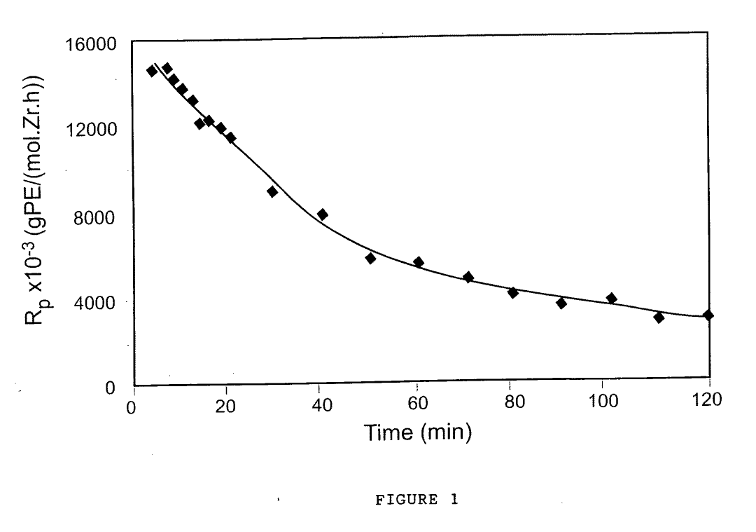

The polymerization reactions of the present invention show characteristic rate-time profiles with the instantaneous rate of polymerization reaching a maximum value within about 3 to 12 minutes and preferably within about 5 to 10 minutes. After this the rate of polymerization decreases gradually with the polymerization time. The extent of this decrease depends amongst others on the temperature and other polymerization conditions. However, even after several hours of polymerization the supported catalyst system of the present invention shows a high activity which can also be derived from FIG. 1.

U.S. Pat. No. 5,869,417 discloses a process for preparing a metallocene catalyst for olefin polymerisation in the presence of MCM-41 and Faujasite zeolites. U.S. Pat. No. 5,869,417 does not disclose the use of bis-(N-[(3-t-butylsalicylidene)anilinato]zirconium (IV)-dichloride).

Paulino et al. (Catalysis Communications, 5 (2004) 5-7) and Chen et al. (Polymer 46 (2005) 11093-11098) are directed to ethylene polymerisations in the presence of MCM 41. However MCM 41 and MCM 48 have different properties. Differences include for example the organization of the particles and the three dimensional channel system of MCM 48 in contrast to the one dimensional channel system of MCM 41. Paulino and Chen do not disclose the use of bis-(N-[(3-t-butylsalicylidene)anilinato]zirconium (IV)-dichloride).

The invention is elucidated on the basis of the following non-limiting examples.

### EXAMPLE 1

### Synthesis of Bis-(N-[(3-t-butylsalicylidene)anilinato]zirconium (IV)-dichloride)

A 250 cm³ round bottomed flask was thoroughly purged with dried nitrogen, after which 80 cm³ of ethanol, 1.42 g (15.2 mmol) of aniline and 2.7 g (15.2 mmol) of 3-t-butylsalicylaldehyde were added and stirred at room temperature for 24 hours. The solvent was removed under reduced pressure and a further 80 cm³ of ethanol were added and the mixture was stirred at room temperature for 12 hours. This solution was concentrated under reduced pressure to yield 3.5 g (13.8 mmol, yield: 90%) of solid N-(3-tert-butylsalicylidene)aniline.

A 250 cm³ round bottomed flask was thoroughly purged with argon, after which 3.5 g (13.8 mmol) of the obtained solid N-(3-tert-butylsalicylidene)aniline and 140 cm³ of tetrahydrofuran were added. The solution was cooled to −78° C. and stirred. Then 9.4 cm³ of a solution of n-butyllithium (3.5 mmol) in n-hexane (14.5 mmol) were added drop wise with stirring over a period of 6 minutes. The temperature was slowly raised to room temperature. Stirring was continued at room temperature for a further 4 hours after which 25 cm³ of tetrahydrofuran were added with stirring. This solution was added drop wise to a solution of 1.6 g of zirconium tetrachloride (6.8 mmol) in 65 cm³ of tetrahydrofuran which had been cooled to −78° C. The solution temperature was raised slowly to room temperature, the solution stirred for 3 hours and further stirred for 6 hours under reflux. The reaction solution was concentrated under reduced pressure and the solid precipitate so obtained was washed with 100 cm³ methylene chloride.

The solid catalyst component was analyzed by microanalysis and found to contain 13.0% by weight of Zr; 55.5% by weight of C, 5.8% by weight of H and 3.5% by weight of N. The structure according to ¹H and ¹³C NMR spectroscopy was (bis(N-[(3-t-butylsalicylidene) anilinato]zirconium (1V)-dichloride).

### EXAMPLE 2

### Preparation of the Supported Catalyst Precursor

10 g of a MCM-48 zeolite were placed in a combustion boat which was placed in the middle of a temperature programmed furnace. The furnace was switched on and the temperature increased 1° C. per minute up to 600° C. and maintained at this value for 6 hours before being allowed to cool to room temperature. The MCM-48 was transferred to a flask and the flask was heated to 260° C. for 3 hours under vacuum (10⁻² mmHg). Finally, the MCM-48S was cooled to room temperature under an atmosphere of dried nitrogen.

2 g of this MCM-48 were placed in a 100 cm³ CPR and then 7.0 cm³ MAO solution (5 by weight Al) in 30 cm³ toluene added. The mixture was stirred at 50° C. for 3 hours under an atmosphere of dried nitrogen and then filtered. The resulting solid material was washed eight times with 30 cm³ portions of toluene at 50° C. Finally the solid in the CPR was dried at 70° C. for 2 hours using a nitrogen purge and vacuum system. This solid material was placed in a round bottomed flask and 20 cm³ heptane added. Microanalysis of the MCM-48 supported MAO material showed that it contained 5.6% by weight Al.

### EXAMPLE 3

### Polymerisation

A Büchi polymerization reactor was heated initially to a 85° C. using the water jacket, evacuated and filled with dried nitrogen. Then 250 cm³ of dried heptarie were transferred under nitrogen pressure from a solvent storage Winchester into the Büchi reactor. The heptane was refluxed for 20 minutes at 60° C. under vacuum. The ethylene monomer supply system was switched on and the reactor purged three times with ethylene monomer, switching alternatively to vacuum and to the ethylene supply system. The heptane diluent was saturated with ethylene at atmospheric pressure, after which 3.0 cm³ of a solution containing 10 cm³ trisobutylaluminum (TIBAL) diluted with 20 cm³ heptane were injected into the reactor. This injection was followed by the injection of a precontacted (2 min) mixture containing g of the solid supported catalyst precursor prepared as described in Example 2, slurried in 2.0 cm³ of heptane, and 2.2×10⁻³ g catalyst, prepared as described in Example 1, dissolved in 2.0 cm² of heptane. The reactor temperature was raised to 60° C. and ethylene polymerization carried out for 2 hour, with ethylene being supplied on demand to maintain a total reactor pressure of 6 bar. At the end of the polymerization the ethylene supply was closed off and the polymer produced removed via the stainless steel screw plug on the reactor base. The polymer slurry was left overnight in a fumecupboard and the solid polymer isolated by filtration and dried in a vacuum oven for 4 hours at 70° C. before a final drying at 60° C. for 24 hours in a normal oven.

26 g polyethylene were recovered which corresponded to an average rate of polymerization of 3.9×10⁺⁶ g polyethylene (mol Zr·h)⁻¹. No reactor fouling took place and the morphology of the polymer which was isolated was very good. The polymer was particulate and the particles were spherical. The bulk density of the polymer was 0.24 g/cm³.

### EXAMPLE 4

### Polymerisation

The Büchi polymerization reactor was heated initially to a 85° C. using the water jacket, evacuated and filled with dried nitrogen. Then 250 cm³ of dried heptane were transferred under nitrogen pressure from a solvent storage Winchester into the Büchi reactor. The heptane was refluxed for 20 minutes at 60° C. under vacuum. The ethylene monomer supply system was switched on and the reactor purged three times with ethylene monomer, switching alternatively to vacuum and to the ethylene supply system. The heptane diluent was saturated with ethylene at atmospheric pressure, after which 0.84 cm³ triethyl aluminum (TEA) were injected into the reactor. This injection was followed by the injection of a precontacted (2 min) mixture containing 0.47 g of the supported solid catalyst precursor prepared as described in Example 2, slurried in 2.0 cm³ of heptane, and 2.2×10⁻³ g catalyst, prepared as described in Example 1, dissolved in 2.0 cm² of heptane. The reactor temperature was raised to 60° C. and ethylene polymerization carried out for 2 hours, with ethylene being supplied on demand to maintain a total reactor pressure of 6 bar. At the end of the polymerization the ethylene supply was closed off and the polymer produced removed via the stainless steel screw plug on the reactor base. The polymer slurry was left overnight in a fume cupboard and the solid polymer isolated by filtration and dried in a vacuum oven for 4 hours at 70° C. before a final drying at 60° C. for 24 hours in a normal oven.

20 g polyethylene were recovered which corresponded to an average rate of polymerization of 3.0×10⁺⁶ g polyethylene (mol Zr·h)⁻¹. No reactor fouling took place and the morphology of the polymer which was isolated was very good. The polymer was particulate and the particles were spherical. The bulk density of the polymer was 0.24 g/cm³.

### EXAMPLE 5

### Polymerisation

The Büchi polymerization reactor was heated initially to 85° C. using the water jacket, evacuated and filled with dried nitrogen. Then 250 cm³ of dried heptane were transferred under nitrogen pressure from a solvent storage Winchester into the Büchi reactor. The heptane was refluxed for 20 minutes at 60° C. under vacuum. The ethylene monomer supply system was switched on and the reactor purged three times with ethylene monomer, switching alternatively to vacuum and to the ethylene supply system. The heptane diluent was saturated with ethylene at atmospheric pressure, after which 3.0 cm³ of a solution containing 10 cm³ TIBAL diluted with 20 cm³ heptane and 2 cm³ 1-octene were injected into the reactor. These injections were followed by the injection of a pre contacted (2 min) mixture containing 0.47 g of the solid supported catalyst precursor prepared as described in Example 6, slurried in 2.0 cm³ of heptane, and 2.2×10⁻³ g catalyst, prepared as described in Example 1, dissolved in 2.0 cm³ of heptane. The reactor temperature was raised to 60° C. and ethylene polymerization carried out for 2 hours, with ethylene being supplied on demand to maintain a total reactor pressure of 6 bar. At the end of the polymerization the ethylene supply was closed off and the polymer produced removed via the stainless steel screw plug on the reactor base. The polymer slurry was left overnight in a fume cupboard and the solid polymer isolated by filtration and dried in a vacuum oven for 4 hours at 70° C. before a final drying at 60° C. for 24 hours in a normal oven.

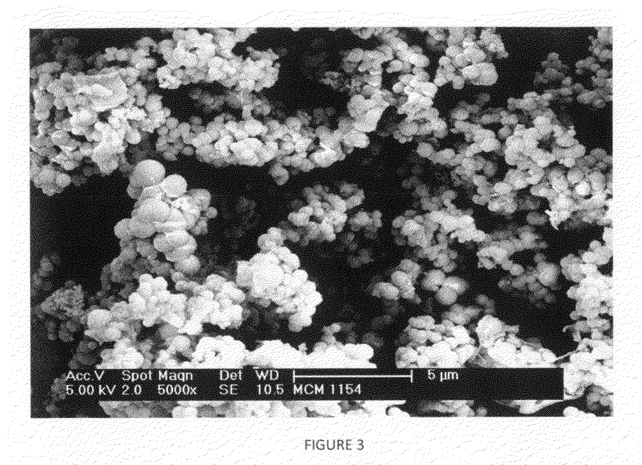

35 g polyethylene were recovered which corresponded to an average rate of polymerization of 5.4×10⁺⁶ g polyethylene (mol Zr·h)⁻¹. No reactor fouling took place and the morphology of the polymer, which was isolated, was very good. The polymer was particulate and the particles were spherical. The bulk density of the polymer was 0.26 g/cm³. A SEM (Scanning electron microscopy) picture of the polymer is shown in FIG. 3.

### COMPARATIVE EXAMPLE A

### Homogeneous Polymerization

A 1 litre Büchi polymerization reactor (BEP 280) was heated initially to 85° C. using the water jacket, evacuated and filled with dried nitrogen. 250 cm³ of dried heptane were transferred under nitrogen pressure from a solvent storage Winchester into the Büchi reactor. The heptane was refluxed for 20 minutes at 25° C. under vacuum. The ethylene monomer supply system was switched on and the reactor purged three times with ethylene monomer, switching alternatively to vacuum and to the ethylene supply system. The heptane diluent was saturated at 25° C. with ethylene at atmospheric pressure, after which 2.0 cm³ of MMAO solution (5 wt % Al) were injected into the reactor. Finally, 0.0043 g of the solid catalyst, prepared as described in Example 1, and slurried in 2.0 cm³ heptane, were injected into the reactor. Ethylene polymerization was carried out for 30 minutes, with ethylene being supplied on demand to maintain a total reactor pressure of 1 bar. The polymerization reaction was very rapid with the evolution of much heat resulting in loss of temperature control. The temperature rose from 25° C. to 80° C. during the 30 minutes polymerization.

At the end of the polymerization the ethylene supply was closed off and the polymer produced removed via the stainless steel screw plug on the reactor base. The polymer slurry was left overnight in a fume cupboard and the solid polymer isolated by filtration and dried in a vacuum oven for 4 hours at 70° C. before the final drying at 60° C. during 24 hours in a normal oven. 61 g polyethylene were recovered which corresponded to an average polymerization rate of 2.1×10⁺⁷ g polyethylene (mol Zr·h)⁻¹.

Fouling of the reactor took place during polymerization with polymer adhering to the stirrer and to the reactor walls. The polymer isolated had a very poor morphology and was lumpy and powdery. The polymer bulk density was unacceptable.

### COMPARATIVE EXAMPLE B

### Preparation of Catalyst Component A

10 g MS 3050 silica (a product of PQ Corporation) were placed in a combination boat, which was placed in the middle of the furnace. The furnace was switched on and the temperature increased 2° C. per minute under a stream of dried nitrogen to 500° C. and maintained at this value for 6 hours before being allowed to cool to room temperature. The silica was transferred to a flask, the flask evacuated (10⁻² mmHg) and heated at 260° C. for 3 hours. Finally the silica was cooled to room temperature under a nitrogen atmosphere.

2.00 g dehydrated silica were placed in a 100 cm³ catalyst preparation reactor (CPR), consisting of a cylindrical three-necked flask fitted with a sinter disc (No. 2 porosity) and a side arm with a tap, which had been thoroughly purged with dried nitrogen. 3.6 cm³ MAO solution (5 wt %) in 30 cm³ toluene were added. The mixture was stirred at 50° C. for 2 hours under dry nitrogen and then filtered. The resulting solid was washed eight times with 30 cm³ portions of toluene at 50° C. Microanalysis showed that this solid contained 0.20% Al.

0.301 g of the solid catalyst, prepared as described in Example 1, and 30 cm³ heptane were added to the CPR and the mixture stirred at 70° C. for 6 hours under dry nitrogen. The mixture was filtered and the solid washed eight times with 15 cm³ portions of heptane at 70° C. Finally the solid in the CPR was dried at 70° C. for 2 hours using a nitrogen purge and vacuum system, and placed in a round bottomed flask and 20 cm³ heptane added. The solid supported catalyst component was analyzed by microanalysis and found to contain 0.14% Zr by weight.

### COMPARATIVE EXAMPLE C

### Homogeneous Polymerization

The Büchi polymerization reactor was heated initially to 85° C. using the water jacket, evacuated and filled with dried nitrogen. 250 cm³ of dried heptane were transferred under nitrogen pressure from a solvent storage Winchester into the Büchi reactor. The heptane was refluxed for 20 minutes at 40° C. under vacuum. The ethylene monomer supply system was switched on and the reactor purged three times with ethylene monomer, switching alternatively to vacuum and to the ethylene supply system. The heptane diluent was saturated at 40° C. with ethylene at atmospheric pressure, after which 1.0 cm³ of MMAO solution (7 wt % Al) was injected into the reactor. This injection was followed by injection of 0.9 g of the solid Catalyst Component A, prepared as described in Comparative Example B and slurried in 4.5 cm³ of heptane. The reactor temperature was raised to 40° C. and ethylene polymerization carried out for 1 hour, with ethylene being supplied on demand to maintain a total reactor pressure of 6 bar. At the end of the polymerization the ethylene supply was closed off and the polymer produced removed via the stainless steel screw plug on the reactor base. The polymer slurry was left overnight in a fume cupboard and the solid polymer isolated by filtration and dried in a vacuum oven for 4 hours at 70° C. before a final drying at 60° C. for 24 hours in a normal oven.

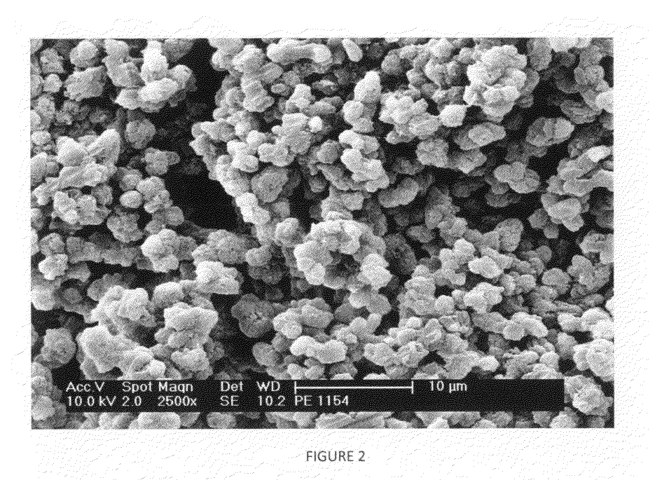

8 g of polyethylene were recovered which corresponded to an average rate of polymerization of 6.0×10⁺⁵ g polyethylene (mol Zr·h)⁻¹. The polymer which was isolated had poor morphology and some fouling of the reactor took place with polymer adhering to the reactor walls and stirrer. The polymer bulk density was 0.15 g/cm³. A SEM (Scanning electron microscopy) picture of the polymer is shown in FIG. 2.

### COMPARATIVE EXAMPLE D

### Homogeneous Polymerization

The Büchi polymerization reactor was heated initially to a 85° C. using the water jacket, evacuated and filled with dried nitrogen. 250 cm³ of dried heptane were transferred under nitrogen pressure from a solvent storage Winchester into the Büchi reactor. The heptane was refluxed for 20 minutes at 40° C. under vacuum. The ethylene monomer supply system was switched on and the reactor purged three times with ethylene monomer, switching alternatively to vacuum and to the ethylene supply system. The heptane diluent was saturated at 40° C. with ethylene at atmospheric pressure, after which 1.0 cm³ of MMAO solution (7 wt % Al) was injected into the reactor followed by injection of 1.0 cm³ 1-octene (98%). These injections were followed by injection of 0.9 g of the solid Catalyst Component A, prepared as described in Example 3, and slurried in 4.5 cm³ of heptane. The reactor temperature was raised to 40° C. and ethylene polymerization carried out for 1 hour, with ethylene being supplied on demand to maintain a total reactor pressure of 6 bar. At the end of the polymerization the ethylene supply was closed off and the polymer produced removed via the stainless steel screw plug on the reactor base. The polymer slurry was left overnight in a fume cupboard and the solid polymer isolated by filtration and dried in a vacuum oven for 4 hours at 70° C. before a final drying at 60° C. for 24 hours in a normal oven.

8 g of polyethylene were recovered which corresponded to an average rate of polymerization of 6.0×10⁺⁵ polyethylene (mol Zr·h)⁻¹. The polymer, which was isolated, had relatively poor morphology and some fouling of the reactor took place with polymer adhering to the reactor walls and stirrer. The bulk density of the polymer was 0.17 g/cm³.

### COMPARATIVE EXAMPLE E

### According to Example 163 of EP 0 874 005 A1

### a) Preparation of Supported Catalyst

In about 30 ml of toluene 2 g of silica of CS 2040 (a product of PQ Corporation) having been dried at 250° C. for 12 hours was suspended, and the suspension was cooled to 0° C. Then, 11.5 ml methylaluminoxane (MAO) solution (Al=1.33 mol/l) was drop wise added. During the addition, the temperature of the system was maintained at 0° C. The reaction was conducted at 0° C. for 30 minutes. Then, the temperature of the system was raised up to 95° C., and was kept at this temperature for about 20 hours. The temperature of the system was then lowered to 60° C., and the supernatant liquid was removed. The resulting solid catalyst precursor component was washed twice with 40 ml toluene and resuspended in 10.6 ml of toluene. Then, bis-(N-[(3-t-butylsalicylidene)anilinato]titanium (IV)-dichloride) (8 mmol/l) was added drop wise. This suspension was stored at room temperature for 24 hours. The resulting solid supported catalyst was washed two times with 100 ml of hexane.

### b) Polymerization Reaction

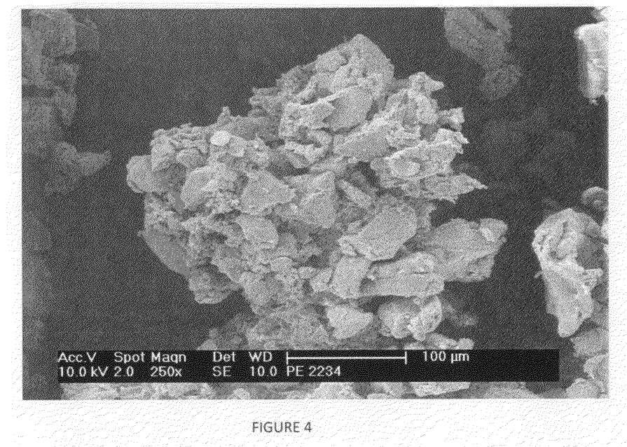

In a reaction vessel thoroughly purged with nitrogen 250 ml of heptane were introduced, and the gas phase and the liquid phase were saturated with ethylene at 50° C. Then, 2 ml of the catalyst slurry prepared according to a) were added (furnishing a titanium concentration of about 4×1000⁻³ mmol/l), and polymerization was preformed for 90 minutes under an ethylene pressure of 5 bar. The polymer suspension obtained was filtered, washed with hexane and dried under vacuum tried at 80° C. for 10 hours, to obtain 1.6 g polyethylene. The polymerization activity was 1063 kg polyethylene/mol·Ti·h. A SEM picture of the polyethylene produced is depicted in FIG. 4.

The examples show that the supported catalyst according to the present invention has a high activity even with lower amounts of aluminoxane as co catalyst. The use of the catalyst according to the invention results in olefin (co)polymers with a good morphology and a high bulk density. Furthermore no or substantially no reactor fouling of the polymerization reactor takes place.

1. A supported catalyst comprising at least one supported catalyst precursor and at least one transition metal complex wherein the precursor comprises a solid particulate support material in the form of mesoporous silicate structure MCM-48 which has been treated with an aluminoxane compound and/or an organoaluminum compound and the metal complex is a transition metal complex of a Group 4 transition metal of the periodic system being coordinative connected to at least two phenoxy-imine ligands.

2. The supported catalyst according to claim 1 wherein the precursor further comprises a support material selected from the group consisting of silicium-, aluminum-, magnesium-, titanium-, zirconium-, borium-, calcium- or zinc-oxide, aluminum silicate, polysiloxane, sheet silicate, zeolite, clay, metal halide, a polymer and/or a mixed oxide.

3. The supported catalyst according to claim 2, wherein the solid particulate support material comprises MCM-48 and silicium oxide and/or aluminum oxide.

4. The supported catalyst according to claim 1, wherein the support material is thermal and/or chemical pre-treated prior to being treated with an aluminoxane compound and/or an organoaluminum compound at a temperature

5. The supported catalyst according to claim 1 wherein the transition metal complex is represented by the formula: 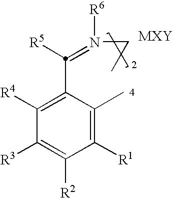
wherein
M=a Group 4 transition metal,
A=selected from the group consisting of O, S or N—R⁷,
R¹ to R⁷=the same or different and is hydrogen or a hydrocarbon radical containing from 1 to 21 carbon atoms, a silicon-containing hydrocarbon radical, or a hydrocarbon radical wherein two carbon atoms are joined together to form a C₄- to C₆-ring, or halogen or an alkoxy radical,
X=halide and
Y=halide

6. The supported catalyst according to claim 5 wherein
M=Zr,
A=O,
R¹=t-butyl,
R² to R⁵=H,
R⁶=phenyl, and
X, Y=chloride

7. The supported catalyst according to claim 1 wherein the transition metal complex is bis-(N-[(3-t-butylsalicylidene)anilinato]zirconium (IV)-dichloride).

8. A process for the preparation of a supported catalyst comprising the steps of:
a) providing at least one solid particulate support material in the form of mesoporous silicate structure MCM-48,
b) forming a slurry of said particulate support material in an inert diluent and mixing said slurry with at least one aluminoxane compound and/or at least one organoaluminum compound or mixing said support material to an aluminoxane compound and/or at least one organoaluminum compound in an inert diluent,
c) isolating the solid material obtained in step b),
d) preparing a slurry from the solid material obtained in step c) in an inert diluent,
e) mixing the slurry obtained in step d) and the Group 4 transition metal complex being coordinative connected to at least two phenoxy-imine ligands in an inert diluent.

9. A process for the preparation of a (co)polymer of ethylenically unsaturated monomers comprising the steps of:
a) adding at least one ethylenically unsaturated monomer to a reaction vessel,
b) adding a supported catalyst comprising at least one supported catalyst precursor and at least one transition metal complex wherein the precursor comprises a solid particulate support material in the form of mesoporous silicate structure MCM-48 which has been treated with an aluminoxane compound and/or an organoaluminum compound and the metal complex is a transition metal complex of a Group 4 transition metal of the periodic system being coordinative connected to at least two phenoxy-imine ligands to the reaction vessel,
c) (co)polymerizing the ethylenically unsaturated monomer(s) and
d) isolating the prepared (co)polymer.

10. A process for the preparation of a (co)polymer of ethylenically unsaturated monomers comprising the steps of:
a) adding of at least one ethylenically unsaturated monomer to an inert diluent in a reaction vessel,
b) mixing the precursor comprising a solid particulate support material in the form of mesoporous silicate structure MCM-48 and the at least one transition metal complex of at least one Group 4 transition metal being coordinative connected to at least two phenoxy-imine ligands in an inert diluent,
c) adding the mixture obtained according to step b) to the at least one ethylenically unsaturated monomer compound as obtained in step a),
d) adding at least one aluminoxane compound and/or an organoaluminum compound in an inert diluent,
e) polymerizing the ethylenically unsaturated monomer(s), and
f) isolating the prepared (co)polymer.

11. A process for the preparation of a (co)polymer of ethylenically unsaturated monomers comprising the steps of:
a) adding of at least one ethylenically unsaturated monomer to an inert diluent in a reaction vessel,
b) adding a solid particulate support material in the form of mesoporous silicate structure MCM-48
c) adding at least one transition metal complex of at least one Group 4 transition metal being coordinative connected to at least two phenoxy-imine ligands in an inert diluent,
d) (co)polymerizing the ethylenically unsaturated monomer(s) and
e) isolating the prepared (co)polymer.

12. (canceled)

13. (canceled)
